(19) United States
(12) Patent Application Publication
(10) Pub. No.: US 2021/0273735 A1
(43) Pub. Date: Sep. 2, 2021

(54) METHOD AND APPARATUS USED IN WLAN NETWORKS

(71) Applicant: Intel Corporation, Santa Clara, CA (US)

(72) Inventors: Claudio Da Silva, Portland, OR (US); Cheng Chen, Portland, OR (US); Carlos Cordeiro, Portland, OR (US); Assaf Gurevitz, Ramat Hasharon (IL); Ofir Klein, Petah Tikva (IL); Uri Parker, Shimshit (IL); Bahareh Sadeghi, Portland, OR (US)

(73) Assignee: Intel Corporation, Santa Clara, CA (US)

(21) Appl. No.: 17/324,139

(22) Filed: May 19, 2021

(51) Int. Cl. H04B 17/336; H04W 24/08

(52) U.S. Cl. CPC H04B 17/336; H04W 84/12; H04W 24/08

(57) ABSTRACT

The application provides an apparatus for a STA, comprising a PHY circuitry and a MAC circuitry, wherein the PHY circuitry is configured to: obtain WLAN sensing measurements; provide the WLAN sensing measurements to the MAC circuitry via a RXVECTOR parameter, wherein the RXVECTOR parameter allows for the PHY layer of the STA to inform the MAC layer of the STA of the WLAN sensing measurements.

### TECHNICAL FIELD

Embodiments of the present disclosure generally relate to wireless communications in a wireless local area network (WLAN), and in particular, to a method and apparatus used in a WLAN.

### BACKGROUND

WLAN sensing is the use, by a WLAN sensing capable STA(s), of received WLAN signals to detect feature(s) (e.g., range, velocity, angular, motion, presence or proximity, gesture, etc.) of an intended target(s) (e.g., object, human, animal, etc.) in a given environment (e.g., room, house, vehicles, enterprise, etc).

The most common measurement used currently by sub-7 GHz WLAN sensing applications is Channel State Information (CSI); that is, the frequency response (CFR) of the channel. The IEEE 802.11 standard already defines the training symbols necessary for a STA to estimate CSI (LTFs), and current Wi-Fi implementations make use of the estimated CSI (CFR) to equalize the received signal before data detection. However, because current Wi-Fi implementations obtain CSI estimates for PHY-level processing only, there is no need and no mechanism defined in the 802.11 standard for CSI estimates to be retrieved by layers above the MAC.

Current WLAN sensing applications have been developed by relying on proprietary interfaces and requires the use of specific chipsets/vendors. There is currently no mechanism defined in the IEEE 802.11 standard to support the exchange of sensing measurements.

### BRIEF DESCRIPTION OF THE DRAWINGS

Embodiments of the disclosure will be illustrated, by way of example and not limitation, in conjunction with the figures of the accompanying drawings in which like reference numerals refer to similar elements and wherein:

FIG. 1 is a network diagram illustrating an example network environment according to some example embodiments of the disclosure.

FIG. 2 is a schematic diagram of amplitude of channel frequency responses (CFRs) obtained with multiple PPDUs over time in static and dynamic environments.

FIG. 3 is a flowchart showing a method 300 according to some example embodiments of the disclosure.

FIG. 4 is a schematic diagram of the format of a CSI Measurement Report Control field according to some example embodiments of the disclosure.

FIG. 5 is a flowchart showing a method 500 according to some example embodiments of the disclosure.

FIG. 6 is a functional diagram of an exemplary communication station 600, in accordance with one or more example embodiments of the disclosure.

FIG. 7 is a block diagram of an example of a machine or system 600 upon which any one or more of the techniques (e.g., methodologies) discussed herein may be performed.

FIG. 8 is a block diagram of a radio architecture 800A, 800B in accordance with some embodiments that may be implemented in any one of APs 104 and/or the user devices 102 of FIG. 1.

FIG. 9 illustrates WLAN FEM circuitry 804a in accordance with some embodiments.

FIG. 10 illustrates radio IC circuitry 806a in accordance with some embodiments.

FIG. 11 illustrates a functional block diagram of baseband processing circuitry 908a in accordance with some embodiments.

### DETAILED DESCRIPTION

Various aspects of the illustrative embodiments will be described using terms commonly employed by those skilled in the art to convey the substance of the disclosure to others skilled in the art. However, it will be apparent to those skilled in the art that many alternate embodiments may be practiced using portions of the described aspects. For purposes of explanation, specific numbers, materials, and configurations are set forth in order to provide a thorough understanding of the illustrative embodiments. However, it will be apparent to those skilled in the art that alternate embodiments may be practiced without the specific details. In other instances, well known features may have been omitted or simplified in order to avoid obscuring the illustrative embodiments.

Further, various operations will be described as multiple discrete operations, in turn, in a manner that is most helpful in understanding the illustrative embodiments; however, the order of description should not be construed as to imply that these operations are necessarily order dependent. In particular, these operations need not be performed in the order of presentation.

The phrases “in an embodiment” “in one embodiment” and “in some embodiments” are used repeatedly herein. The phrase generally does not refer to the same embodiment; however, it may. The terms “comprising,” “having,” and “including” are synonymous, unless the context dictates otherwise. The phrases “A or B” and “A/B” mean “(A), (B), or (A and B).”

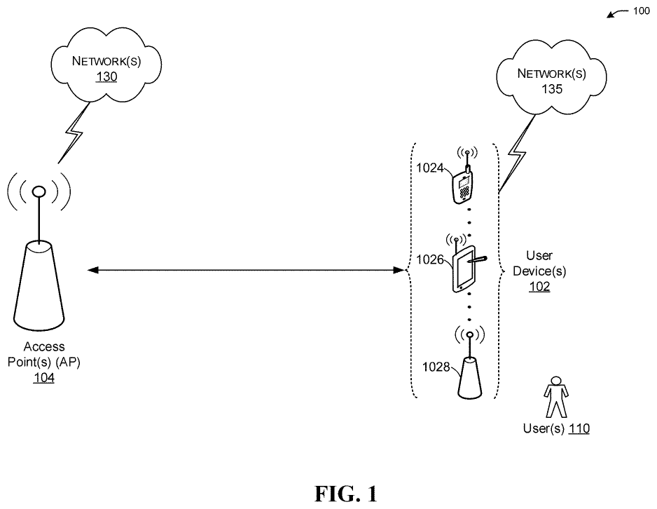

FIG. 1 is a network diagram illustrating an example network environment according to some example embodiments of the disclosure. As shown in FIG. 1, a wireless network 100 may include one or more user devices 102 and one or more access points (APs) 104, which may communicate in accordance with IEEE 802.11 communication standards. The user devices 102 may be mobile devices that are non-stationary (e.g., not having fixed locations) or may be stationary devices.

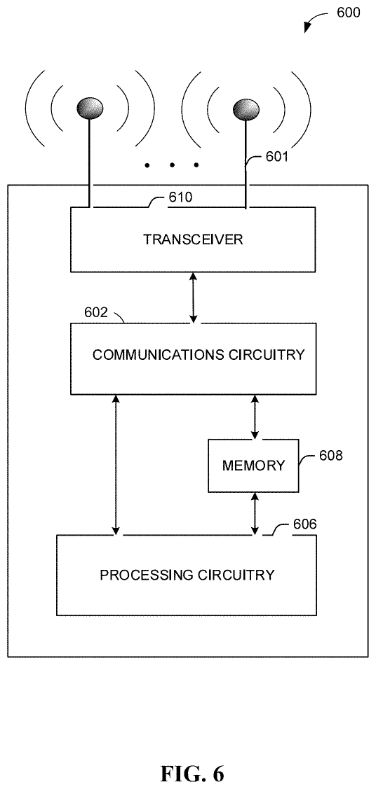

In some embodiments, the user devices 102 and APs 104 may include one or more function modules similar to those in the functional diagram of FIG. 6 and/or the example machine/system of FIG. 6.

The one or more user devices 102 and/or APs 104 may be operable by one or more users 110. It should be noted that any addressable unit may be a station (STA). A STA may take on multiple distinct characteristics, each of which shape its function. For example, a single addressable unit might simultaneously be a portable STA, a quality-of-service (QoS) STA, a dependent STA, and a hidden STA. The one or more user devices 102 and the one or more APs 104 may be STAs. The one or more user devices 102 and/or APs 104 may operate as a personal basic service set (PBSS) control point/access point (PCP/AP). The user devices 102 (e.g., 1024, 1026, or 1028) and/or APs 104 may include any suitable processor-driven device including, but not limited to, a mobile device or a non-mobile, e.g., a static device. For example, the user devices 102 and/or APs 104 may include, a user equipment (UE), a station (STA), an access point (AP), a software enabled AP (SoftAP), a personal computer (PC), a wearable wireless device (e.g., bracelet, watch, glasses, ring, etc.), a desktop computer, a mobile computer, a laptop computer, an Ultrabook™ computer, a notebook computer, a tablet computer, a server computer, a handheld computer, a handheld device, an internet of things (IoT) device, a sensor device, a personal digital assistant (PDA) device, a handheld PDA device, an on-board device, an off-board device, a hybrid device (e.g., combining cellular phone functionalities with PDA device functionalities), a consumer device, a vehicular device, a non-vehicular device, a mobile or portable device, a non-mobile or non-portable device, a mobile phone, a cellular telephone, a personal communications service (PCS) device, a PDA device which incorporates a wireless communication device, a mobile or portable global positioning system (GPS) device, a digital video broadcasting (DVB) device, a relatively small computing device, a non-desktop computer, a “carry small live large” (CSLL) device, an ultra mobile device (UMD), an ultra mobile PC (UMPC), a mobile internet device (MID), an “origami” device or computing device, a device that supports dynamically composable computing (DCC), a context-aware device, a video device, an audio device, an A/V device, a set-top-box (STB), a blu-ray disc (BD) player, a BD recorder, a digital video disc (DVD) player, a high definition (HD) DVD player, a DVD recorder, a HD DVD recorder, a personal video recorder (PVR), a broadcast HD receiver, a video source, an audio source, a video sink, an audio sink, a stereo tuner, a broadcast radio receiver, a flat panel display, a personal media player (PMP), a digital video camera (DVC), a digital audio player, a speaker, an audio receiver, an audio amplifier, a gaming device, a data source, a data sink, a digital still camera (DSC), a media player, a smartphone, a television, a music player, or the like. Other devices, including smart devices such as lamps, climate control, car components, household components, appliances, etc. may also be included in this list.

As used herein, the term “Internet of Things (IoT) device” is used to refer to any object (e.g., an appliance, a sensor, etc.) that has an addressable interface (e.g., an Internet protocol (IP) address, a Bluetooth identifier (ID), a near-field communication (NFC) ID, etc.) and can transmit information to one or more other devices over a wired or wireless connection. An IoT device may have a passive communication interface, such as a quick response (QR) code, a radio-frequency identification (RFID) tag, an NFC tag, or the like, or an active communication interface, such as a modem, a transceiver, a transmitter-receiver, or the like. An IoT device can have a particular set of attributes (e.g., a device state or status, such as whether the IoT device is on or off, open or closed, idle or active, available for task execution or busy, and so on, a cooling or heating function, an environmental monitoring or recording function, a light-emitting function, a sound-emitting function, etc.) that can be embedded in and/or controlled/monitored by a central processing unit (CPU), microprocessor, ASIC, or the like, and configured for connection to an IoT network such as a local ad-hoc network or the Internet. For example, IoT devices may include, but are not limited to, refrigerators, toasters, ovens, microwaves, freezers, dishwashers, dishes, hand tools, clothes washers, clothes dryers, furnaces, air conditioners, thermostats, televisions, light fixtures, vacuum cleaners, sprinklers, electricity meters, gas meters, etc., so long as the devices are equipped with an addressable communications interface for communicating with the IoT network. IoT devices may also include cell phones, desktop computers, laptop computers, tablet computers, personal digital assistants (PDAs), etc. Accordingly, the IoT network may be comprised of a combination of “legacy” Internet-accessible devices (e.g., laptop or desktop computers, cell phones, etc.) in addition to devices that do not typically have Internet-connectivity (e.g., dishwashers, etc.).

The user devices 102 and/or APs 104 may also include mesh stations in, for example, a mesh network, in accordance with one or more IEEE 802.11 standards and/or 3GPP standards.

Any of the user devices 102 (e.g., user devices 1024, 1026, 1028) and APs 104 may be configured to communicate with each other via one or more communications networks 130 and/or 135 wirelessly or wired. The user devices 102 may also communicate peer-to-peer or directly with each other with or without APs 104. Any of the communications networks 130 and/or 135 may include, but not limited to, any one of a combination of different types of suitable communications networks such as, for example, broadcasting networks, cable networks, public networks (e.g., the Internet), private networks, wireless networks, cellular networks, or any other suitable private and/or public networks. Further, any of the communications networks 130 and/or 135 may have any suitable communication range associated therewith and may include, for example, global networks (e.g., the Internet), metropolitan area networks (MANs), wide area networks (WANs), local area networks (LANs), or personal area networks (PANs). In addition, any of the communications networks 130 and/or 135 may include any type of medium over which network traffic may be carried including, but not limited to, coaxial cable, twisted-pair wire, optical fiber, a hybrid fiber coaxial (HFC) medium, microwave terrestrial transceivers, radio frequency communication mediums, white space communication mediums, ultra-high frequency communication mediums, satellite communication mediums, or any combination thereof.

Any of the user devices 102 (e.g., user devices 1024, 1026, 1028) and APs 104 may include one or more communications antennas. The one or more communications antennas may be any suitable type of antennas corresponding to the communications protocols used by the user devices 102 (e.g., user devices 1024, 1026 and 1028) and APs 104. Some non-limiting examples of suitable communications antennas include Wi-Fi antennas, Institute of Electrical and Electronics Engineers (IEEE) 802.11 family of standards compatible antennas, directional antennas, non-directional antennas, dipole antennas, folded dipole antennas, patch antennas, multiple-input multiple-output (MIMO) antennas, omnidirectional antennas, quasi-omnidirectional antennas, or the like. The one or more communications antennas may be communicatively coupled to a radio component to transmit and/or receive signals, such as communications signals to and/or from the user devices 102 and/or APs 104.

Any of the user devices 102 (e.g., user devices 1024, 1026, 1028) and APs 104 may be configured to perform directional transmission and/or directional reception in conjunction with wirelessly communicating in a wireless network. Any of the user devices 102 (e.g., user devices 1024, 1026, 1028) and APs 104 may be configured to perform such directional transmission and/or reception using a set of multiple antenna arrays (e.g., DMG antenna arrays or the like). Each of the multiple antenna arrays may be used for transmission and/or reception in a particular respective direction or range of directions. Any of the user devices 102 (e.g., user devices 1024, 1026, 1028) and APs 104 may be configured to perform any given directional transmission towards one or more defined transmit sectors. Any of the user devices 102 (e.g., user devices 1024, 1026, 1028) and APs 104 may be configured to perform any given directional reception from one or more defined receive sectors.

MIMO beamforming in a wireless network may be accomplished using radio frequency (RF) beamforming and/or digital beamforming. In some embodiments, in performing a given MIMO transmission, the user devices 102 and/or APs 104 may be configured to use all or a subset of its one or more communications antennas to perform MIMO beamforming.

Any of the user devices 102 (e.g., user devices 1024, 1026, 1028) and APs 104 may include any suitable radio and/or transceiver for transmitting and/or receiving radio frequency (RF) signals in the bandwidth and/or channels corresponding to the communications protocols utilized by any of the user devices 102 and APs 104 to communicate with each other. The radio components may include hardware and/or software to modulate and/or demodulate communications signals according to pre-established transmission protocols. The radio components may further have hardware and/or software instructions to communicate via one or more Wi-Fi and/or Wi-Fi direct protocols, as standardized by the Institute of Electrical and Electronics Engineers (IEEE) 802.11 standards. It should be understood that this list of communication channels in accordance with certain 802.11 standards is only a partial list and that other 802.11 standards may be used (e.g., Next Generation Wi-Fi, or other standards). In some embodiments, non-Wi-Fi protocols may be used for communications between devices, such as Bluetooth, dedicated short-range communication (DSRC), Ultra-High Frequency (UHF) (e.g. IEEE 802.11af, IEEE 802.22), white band frequency (e.g., white spaces), or other packetized radio communications. The radio component may include any known receiver and baseband suitable for communicating via the communications protocols. The radio component may further include a low noise amplifier (LNA), additional signal amplifiers, an analog-to-digital (A/D) converter, one or more buffers, and digital baseband.

Embodiments are provided to indicate a standardized service interface and standardized frame formats necessary for sensing measurements, so as to enable layers above the MAC to request and retrieve (PHY) sensing measurements and enable the exchange of the sensing measurements among STAs.

WLAN sensing implementations typically fall in one of two categories.

In the first category, same device transmits and receives a waveform—similar to conventional radars (e.g., Frequency Modulated Continuous Wave, FMCW). It is usually implemented using mmWave technology (802.11ad/ay) and Doppler processing. Typically used for short-range, high-resolution applications such as gesture recognition.

In the second category, sensing is performed by tracking one or more wireless links between one sensing receiver and one or more sensing transmitters, wherein a sensing transmitter is a STA that transmits PPDUs used for sensing measurements, and a sensing receiver is a STA that receives PPDUs sent by a sensing transmitter and performs sensing measurements. It is usually implemented using sub-7 GHz Wi-Fi technology and may make use of Artificial Intelligence (AI)/Machine Learning (ML) algorithms to classify time-variations in the wireless channels into events/activities. Supports wide coverage (e.g., single-family home) and lower-resolution applications such as home security and smart buildings.

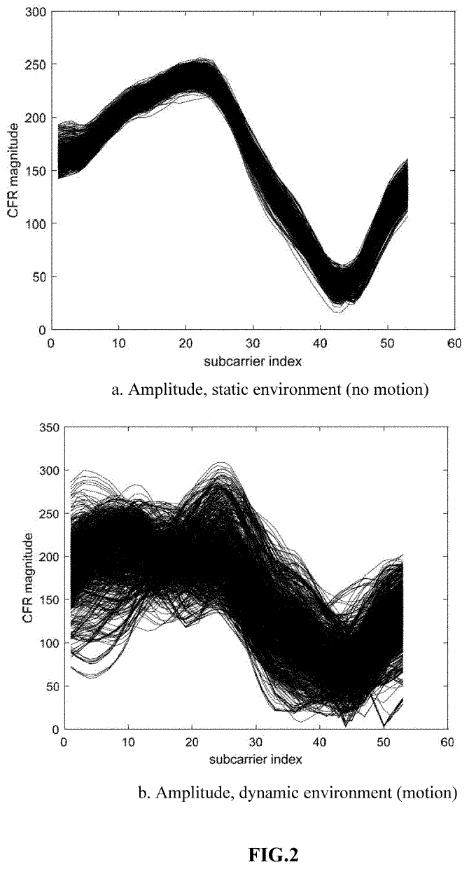

The disclosure focuses on WLAN sensing applications that rely on tracking one or more wireless links over time. Such applications rely on the fact that as a person or object moves around an area, it impacts how a radio signal propagates (e.g., propagation paths are created and destructed generating time-varying multipath fading). An example of the impact of motion to channel estimates obtained with multiple Wi-Fi packets over time is shown in FIG. 2. In FIG. 2, (a) illustrates amplitude of channel frequency responses (CFRs) obtained with multiple PPDUs over time for approximately 3 minutes in a static environment, and (b) illustrates amplitude of CFRs obtained with multiple PPDUs over time for approximately 3 minutes in a dynamic environment. Each curve in FIG. 2 corresponds to a PPDU. In FIG. 2, (a) corresponds to when there was no motion in the room, and (b) corresponds to when there was motion in the room.

In some embodiments, in order to enable WLAN sensing applications that rely on wireless link(s) tracking, a standardized service interface and standardized frame formats necessary for sensing measurements are disclosed to enable layers above the MAC to request and retrieve (PHY) sensing measurements and enable the exchange of the sensing measurements among STAs. Such a standardized interface is necessary to enable Wi-Fi sensing applications to operate seamlessly across chipsets of multiple vendors. A reporting procedure to enable the exchange of sensing measurements among STAs may be supported by WLAN sensing architectures in which the STA that uses CSI measurements obtains them through reporting. That is, one device obtains CSI measurements and sends them (for example, in a MAC frame) to a second device, which is the one that makes use of the measurements.

In some embodiments, it is proposed to enable the sensing measurements made by a STA (1) to be obtained by its upper layers and (2) to be reported to a second STA.

While embodiments herein are specific to the case when the sensing measurement used is CSI, it is important to note that the disclosed definitions are also valid for other channel measurements (such as Signal Noise Ratio (SNR) or any other measure of the radio channel). The extension of the proposed definition to also include other channel measurements is possible and straightforward.

PHY Service Interface for Sensing Measurements

In some embodiments, in order to enable the PHY layer to inform the MAC layer of obtained sensing measurements, for example, CSI measurements, new RXVECTOR parameters are defined to be incorporated into the PHY service interface of each sub-7 GHZ PHY, which comprises HT PHY, VHT PHY, HE PHY, and EHT PHY. In one embodiment, the PHY service interface may be a PHY Service Access Point (SAP) interface.

In some embodiments, the RXVECTOR parameter may comprise a parameter of CSI_ESTIMATE, and wherein the parameter of CSI_ESTIMATE may contains a vector in the number of selected subcarriers that contains the channel measured during the training symbols of the received PPDU.

In some embodiments, the received PPDU may be one of HT PPDU, VHT PPDU, HE PPDU, and EHT PPDU.

In the standard of IEEE 802.11-2020, specifically, in Table 19-1, TXVECTOR and RXVECTOR parameters for HT PHY service interface are defined.

For the HT PHY, in some embodiments, the following RXVECTOR as shown in Table 1 may be defined and added to Table 19-1 [IEEE 802.11-2020]:

TABLE 1
RXVECTOR for the HT PHY

| Parameter | Condition | Value | TXVECTOR | RXVECTOR |
|---|---|---|---|---|
| CSI_ESTIMATE | FORMAT is | Contains a vector in the number | N | See |
| | HT_MF or | of selected subcarriers that contains | | NOTE |
| | HT_GF | the channel measured during the | | |
| | | training symbols of the received | | |
| | | HT PPDU. | | |
| | Otherwise | Not present | N | N |

NOTE
“Y” if dot11CSIMsmtActivated is activated, otherwise “N”.

As shown in Table 1, the RXVECTOR parameter of HT PHY service interface may further comprise a parameter of CSI_ESTIMATE, and wherein when the condition of the PPDU format being HT_MF or HT_GF is satisfied, the parameter of CSI_ESTIMATE may have a value which contains a vector in the number of selected subcarriers, as defined in Table 8 described below, that contains the channel measured during the training symbols of the received HT PPDU. In some embodiments, the parameter of CSI_ESTIMATE presents in the RXVECTOR of HT PHY service interface if dot11CSIMsmtActivated is activated, otherwise not present.

In the standard of IEEE 802.11-2020, specifically, in Table 21-1, TXVECTOR and RXVECTOR parameters for VHT PHY service interface are defined.

For the VHT PHY, in some embodiments, the following RXVECTOR as shown in Table 2 may be defined and added to Table 21-1 [IEEE802.11-2020]:

TABLE 2
RXVECTOR for the VHT PHY

| Parameter | Condition | Value | TXVECTOR | RXVECTOR |
|---|---|---|---|---|
| CSI_ESTIMATE | FORMAT | Contains a vector in the number of | N | See |
| | is VHT | selected subcarriers that contains | | NOTE |
| | | the channel measured during the | | |
| | | training symbols of the received | | |
| | | VHT PPDU. | | |
| | Otherwise | See corresponding entry in | N | N |
| | | Table 19-1 | | |

NOTE
“Y” if dot11CSIMsmtActivated is activated, otherwise “N”.

As shown in Table 2, the RXVECTOR parameter of VHT PHY service interface may further comprise a parameter of CSI_ESTIMATE, and wherein when the condition of the PPDU format being VHT is satisfied, the parameter of CSI_ESTIMATE may have a value which contains a vector in the number of selected subcarriers, as defined in Table 8 described below, that contains the channel measured during the training symbols of the received VHT PPDU. In some embodiments, the parameter of CSI_ESTIMATE presents in the RXVECTOR of VHT PHY service interface if dot11CSIMsmtActivated is activated, otherwise not present.

In the standard of IEEE 802.11ax, specifically, in Table 27-1, TXVECTOR and RXVECTOR parameters for HE PHY service interface are defined.

For the HE PHY, in some embodiments, the following RXVECTOR as shown in Table 3 may be defined and added to Table 27-1 [802.11ax]:

TABLE 3
RXVECTOR for the HE PRY

| Parameter | Condition | Value | TXVECTOR | RXVECTOR |
|---|---|---|---|---|
| CSI_ESTIMATE | FORMAT is | Contains a vector in the number of | N | See |
| | HE_SU, | selected subcarriers that contains | | NOTE |
| | HE_MU, | the channel measured during the | | |
| | HE_ER_SU or | training symbols of the received | | |
| | HE_TB | HE PPDU. | | |
| | Otherwise | See corresponding entry in Table | N | N |
| | | 19-1 or Table 21-1 | | |

NOTE
“Y” if dot11CSIMsmtActivated is activated, otherwise “N”.

As shown in Table 3, the RXVECTOR parameter of HE PHY service interface may further comprise a parameter of CSI_ESTIMATE, and wherein when the condition of the PPDU format being HE_SU, HE_MU, HE_ER_SU or HE_TB is satisfied, the parameter of CSI_ESTIMATE may have a value which contains a vector in the number of selected subcarriers, as defined in Table 8 described below, that contains the channel measured during the training symbols of the received HE PPDU. In some embodiments, the parameter of CSI_ESTIMATE presents in the RXVECTOR of HE PHY service interface if dot11CSIMsmtActivated is activated, otherwise not present.

In the standard of IEEE 802.11be, specifically, in Table 36-1, TXVECTOR and RXVECTOR parameters for EHT PHY service interface are defined.

For the EHT PHY, in some embodiments, the following RXVECTOR as shown in Table 4 may be defined and added to Table 36-1 [802.11be]:

TABLE 4
RXVECTOR for the EHT PHY

| Parameter | Condition | Value | TXVECTOR | RXVECTOR |
|---|---|---|---|---|
| CSI_ESTIMATE | FORMAT is | Contains a vector in the number of | N | See |
| | EHT_MU or | selected subcarriers that contains | | NOTE |
| | EHT_TB | the channel measured during the | | |
| | | training symbols of the received | | |
| | | EHT PPDU. | | |
| | Otherwise | See corresponding entry in Table 19-1, | N | N |
| | | Table 21-1, or Table 27-1. | | |

NOTE
“Y” if dot11CSIMsmtActivated is activated, otherwise “N”.

As shown in Table 4, the RXVECTOR parameter of EHT PHY service interface may further comprise a parameter of CSI_ESTIMATE, and wherein when the condition of the PPDU format being EHT_MU or EHT_TB is satisfied, the parameter of CSI_ESTIMATE may have a value which contains a vector in the number of selected subcarriers, as defined in Table 8 described below, that contains the channel measured during the training symbols of the received EHT PPDU. In some embodiments, the parameter of CSI_ESTIMATE presents in the RXVECTOR of EHT PHY service interface if dot11CSIMsmtActivated is activated, otherwise not present.

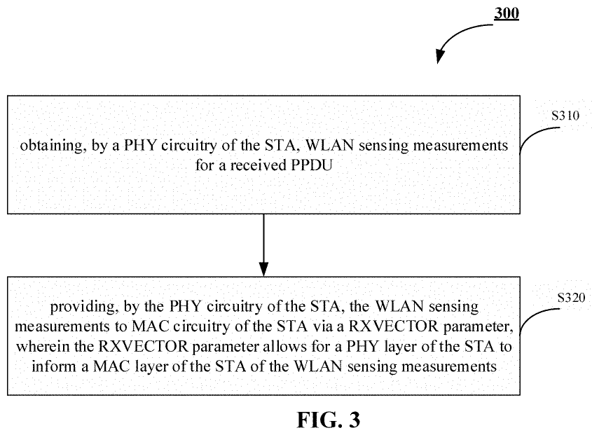

FIG. 3 is a flowchart showing a method 300 for a STA according to some embodiments of the disclosure. In some embodiment, the method 300 may be performed by a STA, e.g., the user device 102 or the AP 104 as shown in FIG. 1, wherein the STA may comprises a PHY circuitry for its PHY layer and a MAC circuitry for its MAC layer. As shown in FIG. 3, the method 300 may include: S310, obtaining, by a PHY circuitry of the STA, WLAN sensing measurements for a received PPDU; 5320, providing, by the PHY circuitry of the STA, the WLAN sensing measurements to MAC circuitry of the STA via a RXVECTOR parameter, wherein the RXVECTOR parameter allows for a PHY layer of the STA to inform a MAC layer of the STA of the WLAN sensing measurements.

In some embodiments, the WLAN sensing measurements may comprise CSI measurements, for example, CSI estimates.

In some embodiments, the WLAN sensing measurements may comprise SNR measurements.

In some embodiments, the WLAN sensing measurements may comprise other measurements of a radio channel.

In some embodiments, the MAC circuitry of the STA may obtain the WLAN sensing measurements based on the RXVECTOR parameter and provide the WLAN sensing measurements to layers above the MAC layer.

Sensing Measurement Reporting

To support WLAN sensing architectures in which the STA that uses sensing measurements obtains the sensing measurements through reporting, new and standardized frames, and different fields within the frames, could be defined. To this end, two frames are disclosed: a Sensing Measurement Report frame and a Protected Sensing Frame.

In some embodiments, the Sensing Measurement Report frame is an Action No Ack frame of category Public. The Sensing Measurement Report frame may comprise a Sensing Measurement Report frame Action field. The format of the sensing measurement report frame Action field is defined in Table 5 below.

TABLE 5
Sensing Measurement Report frame Action field format

| Order | Information |
|---|---|
| 1 | Category |
| 2 | Public Action |
| 3 | CSI Measurement Report Control |
| | (see Table 7 described below) |
| 4 | CSI Measurement Report |
| | (see Table 8 described below) |

As shown in Table 5, the Sensing Measurement Report frame Action field may comprise a Category field, a Public Action field, a CSI Measurement Report Control field and a CSI Measurement Report Field. Specifically, the Category field is defined in section 9.4.1.11 in IEEE 802.11-2020. The Public Action field is defined in section 9.6.7.1 in IEEE 802.11-2020.

In some embodiments, the Protected Sensing Frame may comprise a Category field and an Action field, wherein the Action field is in the octet immediately after the Category field. The value of the Protected Sensing Frame Action field is defined in Table 6 below.

TABLE 6
Protected Sensing Frame Action field values

| Value | Meaning |
|---|---|
| 0 | Reserved |
| 1 | Protected Sensing Measurement Report. The format of |
| | the frame after the action field is identical to the format |
| | of Sensing Measurement Report public action. It is carried |
| | in a Management Action No Ack frame. |
| 2-255 | Reserved |

As shown in Table 6, when the Protected Sensing Frame Action field has the value of 1, it means a Protected Sensing Measurement Report, the format of the frame after the action field is identical to the format of Sensing Measurement Report public action, and it is carried in a Management Action No Ack frame.

In some embodiments, both the Sensing Measurement Report frame and the Protected Sensing Frame comprise a CSI Measurement Report Control field and a CSI Measurement Report field.

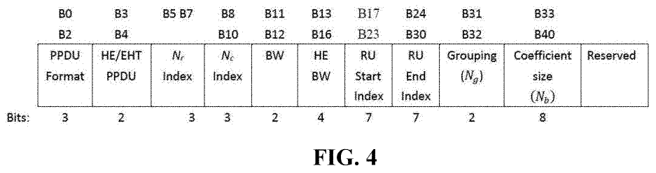

In some embodiments, the CSI Measurement Report Control field is included in every Sensing Measurement Report frame and Protected Sensing frame, and it contains information necessary for a receiving STA, which receives the Sensing Measurement Report frame or the Protected Sensing Frame, to interpret the CSI Measurement Report field. FIG. 4 illustrates the format of the CSI Measurement Report Control field according to some embodiments of the disclosure. As shown in FIG. 4, the CSI Measurement Report Control field may comprise the following subfields: PPDU Format, HE/EHT PPDU, Nr Index, Nc index, BW, HE BW, RU Start Index, RU End Index, Grouping (N_{g}), and Coefficient size (N_{b}). The subfields of the CSI Measurement Report Control field are defined in Table 7.

TABLE 7
Subfields of the CSI Measurement Report Control field

| Subfield | Description |
|---|---|
| PPDU | Indicates the format of the PPDU used in the measurements |
| Format | reported within the frame. |
| | Set to 0 for HT PPDU |
| | Set to 1 for VHT PPDU |
| | Set to 2 for HE PPDU |
| | Set to 3 for EHT PPDU |
| HE/EHT | If the PPDU Format subfield indicates HT PPDU or VHT PPDU, the |
| PPDU | HE/ENT PPDU subfield is reserved. |
| | If the PPDU Format subfield indicates HE PPDU, the HE/EHT PPDU |
| | subfield indicates the PPDU used in the measurements reported |
| | within the frame. |
| | Set to 0 for HE SU PPDU |
| | Set to 1 for HE ER SU PPDU |
| | Set to 2 for HE TB PPDU |
| | Set to 3 for HE MU PPDU |
| | If the PPDU Format subfield indicates EHT PPDU, the HE/ENT PPDU |
| | subfield indicates the PPDU used in the measurements reported |
| | within the frame. |
| | Set to 0 for EHT MU PPDU |
| | Set to 1 for EHT TB PPDU |
| Nᵣ Index | The Nᵣ Index subfield indicates the number of rows, Nᵣ, in the |
| | measured channel and is set to Nᵣ − 1. |
| N_{c} index | The N_{c} Index subfield indicates the number of columns, N_{c}, in the |
| | measured channel and is set to N_{c - 1.} |
| BW | If the PPDU Format subfield indicates HE PPDU or EHT PPDU, the |
| | BW subfield is reserved. |
| | If the PPDU Format subfield indicates HT PPDU, the BW subfield |
| | indicates the width of the channel in which the measurement was |
| | made: |
| | Set to 0 for 20 MHz |
| | Set to 1 for 40 MHz |
| | If the PPDU Format subfield indicates VHT PPDU, the BW subfield |
| | indicates the width of the channel in which the measurement was |
| | made: |
| | Set to 0 for 20 MHz |
| | Set to 1 for 40 MHz |
| | Set to 2 for 80 MHz |
| | Set to 3 for 160 MHz and 80 + 80 MHz |
| HE BW | If the PPDU Format subfield indicates HT PPDU, VHT PPDU, or EHT |
| | PPDU, the BW subfield is reserved. |
| | If the PPDU Format subfield indicates HE PPDU and the HE/EHT |
| | PPDU indicates HE SU PPDU or HE TB PPDU, |
| | Set to 0 for 20 MHz |
| | Set to 1 for 40 MHz |
| | Set to 2 for 80 MHz |
| | Set to 3 for 160 MHz |
| | Set to 4 for 80 + 80 MHz |
| | If the PPDU Format subfield indicates HE PPDU and the HE/EHT |
| | PPDU indicates HE ER SU PPDU, |
| | Set to 0 for the 242-tone RU in the primary 20 MHz channel |
| | Set to 1 for the higher frequency 106-tone RU in the primary 20 |
| | MHz channel |
| | If the PPDU Format subfield indicates HE PPDU and the HE/EHT |
| | PPDU indicates HE MU PPDU, |
| | Set to 0 for full 20 MHz |
| | Set to 1 for full 40 MHz |
| | Set to 2 for full 80 MHz |
| | Set to 3 for full 160 MHz |
| | Set to 4 for 80 + 80 MHz |
| | Set to 5 for HE-CBW-PUNC80-PRI |
| | Set to 6 for HE-CBW-PUNC80-SEC |
| | Set to 7 for HE-CBW-PUNC160-PRI20 |
| | Set to 8 for HE-CBW-PUNC80 + 80-PRI20 |
| | Set to 9 for HE-CBW-PUNC160-SEC40 |
| | Set to 10 for HE-CBW-PUNC80 + 80-SEC40 |
| RU Start | If the PPDU Format subfield indicates HT PPDU, VHT PPDU, or EHT |
| Index | PPDU, the RU Start Index subfield is reserved. |
| | If the PPDU Format subfield indicates HE PPDU, the RU Start Index |
| | subfield indicates the first 26-tone RU for which measurement is |
| | reported. |
| RU End | If the PPDU Format subfield indicates HT PPDU, VHT PPDU, or EHT |
| Index | PPDU, the RU End Index subfield is reserved. |
| | If the PPDU Format subfield indicates HE PPDU, the RU End Index |
| | subfield indicates the last 26-tone RU for which measurement is |
| | reported. |
| Grouping | Indicates the number of carriers grouped into one. |
| (N_{g}) | If the PPDU Format subfield indicates HT PPDU or VHT PPDU, the |
| | Grouping (N_{g}) subfield is: |
| | Set to 0 for N_{g} = 1 (No grouping) |
| | Set to 1 for N_{g} = 2 |
| | Set to 2 for N_{g} = 4 |
| | If the PPDU Format subfield indicates HE PPDU or EHT PPDU, the |
| | Grouping (N_{g}) subfield is: |
| | Set to 0 for N_{g} = 4 |
| | Set to 1 for N_{g} = 16 |
| Coefficient | Indicates the number of bits, N_{b}, in the representation of the real |
| size (N_{b}) | and imaginary parts of each element in the report. |
| | Set to 0 for N_{b} = 6 |
| | Set to 1 for N_{b} = 8 |
| | Set to 2 for N_{b} = 10 |
| | Set to 3 for N_{b} = 12 |

In some embodiments, The CSI Measurement Report field may be used by the Sensing Measurement Report frame and the Protected Sensing frame to carry CSI and/or SNR measurements obtained by a sensing receiver.

CSI measurements may be obtained by the sensing receiver as follows. A sensing transmitter transmits a PPDU with N_{c} space-time streams. Based on this PPDU, for each subcarrier, the sensing receiver estimates an Nᵣ×N_{c} channel, where Nᵣ is the number of receiver chains used to receive the PPDU.

In some embodiments, CSI Measurement Report information has the structure defined in Table 8, and contains channel matrix elements indexed by data and pilot subcarrier index from lowest frequency to highest frequency.

TABLE 8
CSI Measurement Report information

| Field | Size (bits) | Meaning |
|---|---|---|
| Subcarrier 1 | (Nᵣ × | CSI corresponding to subcarrier 1. Includes |
| | N_{c}) × | Nᵣ × N_{c} complex channel coefficients in the |
| | 2N_{b} | order defined in Table 9. For each |
| | | coefficient, their real (N_{b} bits) and |
| | | imaginary (N_{b} bits) parts are included in |
| | | that order. |
| . . . | . . . | . . . |
| Subcarrier N_{SC} | (Nᵣ × | CSI corresponding to subcarrier N_{sc.} |
| | N_{c}) × | Includes Nᵣ × N_{c} complex channel |
| | 2N_{b} | coefficients in the order defined in Table 9. |
| | | For each coefficient, their real (N_{b} bits) and |
| | | imaginary (N_{b} bits) parts are included in |
| | | that order. |
| Average SNR of | 8 | Signal-to-noise ratio at the beamformee for |
| Space-Time | | space-time stream 1 averaged over all |
| Stream 1 | | subcarriers. |
| . . . | . . . | . . . |
| Average SNR of | 8 | Signal-to-noise ratio at the beamformee for |
| Space-Time | | space-time stream N_{c} averaged over all |
| Stream N_{c} | | subcarriers. |

In Table 8, Nᵣ and N_{c} are determined by the Nᵣ Index subfield and the N_{c} Index subfield, respectively, of the CSI Measurement Report Control field (see Table 7). The order in which the Nᵣ×N_{c} complex channel coefficients of a given subcarrier are transmitted is defined in Table 9.

TABLE 9
Transmission order of the complex channel coefficients for each
subcarrierwithin the CSI Measurement Report field

| | Space- | |
|---|---|---|
| | time | Receive |
| Field | stream | chain |
| Channel coefficient 1 | 1 | 1 |
| . . . | . . . | . . . |
| Channel coefficient N_{c} | N_{c} | 1 |
| Channel coefficient N_{c} + 1 | 1 | 2 |
| . . . | . . . | . . . |
| Channel coefficient 2N_{c} | N_{c} | 2 |
| . . . | . . . | . . . |
| Channel coefficient (Nᵣ × N_{c}) | N_{c} | Nᵣ |

In Table 8, N_{sc} is the number of subcarriers reported within the Sensing Measurement Report frame and the Protected Sensing frame. The STA that sends the Sensing Measurement Report frame and the Protected Sensing frame might choose to reduce N_{sc} by using a method referred to as grouping, in which only a single complex channel coefficient is reported for each group of N_{g} adjacent subcarriers. The value N_{g} is given by the Grouping (N_{g}) subfield of the CSI Measurement Report Control field (see Table 7).

N_{sc} is a function of the PPDU Format, BW and Grouping (N_{g}) subfields in the CSI Measurement Report Control field (see Table 7). The subcarrier indices that are reported and their order within each channel estimate vector field (see Table 8) are defined in:
Table 9-58 in standard of IEEE 802.11-2020 if the PPDU Format subfield within the CSI Measurement Report Control field (see Table 7) is set to 0;
Table 9-76 in standard of IEEE 802.11-2020 if the PPDU Format subfield within the CSI Measurement Report Control field (see Table 7) is set to 1;
Table 9-91c, Table 9-91d, and Table 9-91e in standard of IEEE 802.11ax if the PPDU Format subfield within the CSI Measurement Report Control field (see Table 7) is set to 2;
Table 9-91j, Table 9-91k, and Table 9-911 in standard of IEEE 802.11be if the PPDU Format subfield within the CSI Measurement Report Control field (see Table 7) is set to 3.

The Average SNR of Space-Time Stream i subfield in Table 8 is an 8-bit 2s complement integer defined in Table 9-77 in the standard of 802.11-2020. The AvgSNRi in Table 9-77 in the standard of 802.11-2020 is found by computing the SNR per subcarrier in decibels for the subcarriers identified in:
Table 9-58 in the standard of 802.11-2020 if the PPDU Format subfield within the CSI Measurement Report Control field (see Table 7) is set to 0;
Table 9-76 in the standard of 802.11-2020 if the PPDU Format subfield within the CSI Measurement Report Control field (see Table 7) is set to 1;
Table 9-91c, Table 9-91d, and Table 9-91e in the standard of 802.11ax if the PPDU Format subfield within the CSI Measurement Report Control field (see Table 7) is set to 2;
Table 9-91j, Table 9-91k, and Table 9-911 in the standard of 802.11be if the PPDU Format subfield within the CSI Measurement Report Control field (see Table 7) is set to 3, and then computing the arithmetic mean of those values. Each SNR value per subcarrier in stream i (before being averaged) corresponds to the SNR associated with column i of the CSI measurement determined at the sensing receiver.

If the size of the CSI Measurement Report information is not an integer multiple of 8 bits, up to seven zeros are appended to the end of the field to make its size an integer multiple of 8 bits.

It should be noted that as listed in Table 10, the number N_{c} of space-time streams is denoted by different variables for HT, VHT, HE, and EHT PPDU formats.

TABLE 10
Number of space-time streams notation for HT, VHT, HE, and
EHT PPDU formats

| | HE/EHT | Number of | |
|---|---|---|---|
| PPDU | PPDU | space-time | |
| Format | format | streams (N_{c}) | Note |
| HT | Reserved | N_{STS} + N_{ESS} | See 19.3.9.4.6 |
| PPDU | | | [802.11-2020] |
| VHT | Reserved | N_{STS,total} | See 21.3.8.3.5 |
| PPDU | | | [802.11-2020] |
| HE | HE SU | N_{STS} | See 27.3.11.10 |
| PPDU | PPDU | | [802.11ax] |
| | HE ER SU | N_{STS} | See 27.3.11.10 |
| | PPDU | | [802.11ax] |
| | HE MU | N_{STS,r,total} | See 27.3.11.10 |
| | PPDU | | [802.11ax] |
| | HE TB | N_{STS,r,u} | See 27.3.11.10 |
| | PPDU | | [802.11ax] |
| EHT | EHT MU | N_{SS,r,total} | See 36.3.11.10 |
| PPDU | PPDU | | [802.11be] |
| | EHT TB | N_{SS,r,u} | See 36.3.11.10 |
| | PPDU | | [802.11be] |

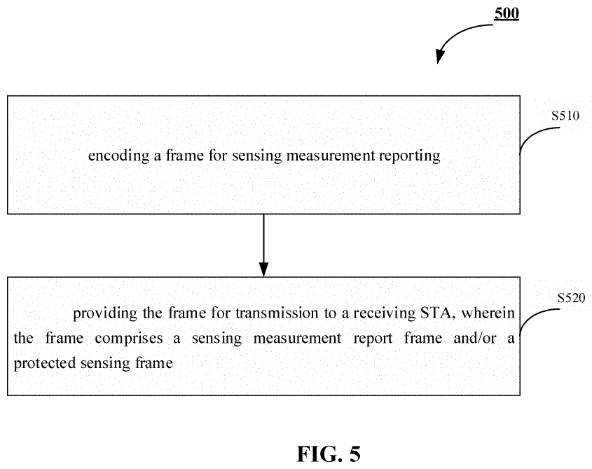

FIG. 5 is a flowchart showing a method 500 for sensing measurement reporting according to some embodiments of the disclosure. In some embodiment, the method 500 may be performed by a STA, e.g., the user device 102 or the AP 104 as shown in FIG. 1. As shown in FIG. 5, the method 500 may include: S510, encoding a frame for sensing measurement reporting; S520, providing the frame for transmission to a receiving STA, wherein the frame comprises a sensing measurement report frame and/or a protected sensing frame.

In some embodiments, the sensing measurement report frame and the protected sensing frame may comprise a CSI Measurement Report Control field and a CSI Measurement Report field.

It should be appreciated that the methods 300 and 500 may be implemented in WLANs complying with IEEE 802.11 standards.

More particularly, the process 300 of FIG. 3 or the process 500 of FIG. 5 may be implemented in one or more modules as a set of logic instructions stored in a machine- or computer-readable storage medium such as random access memory (RAM), read only memory (ROM), programmable ROM (PROM), firmware, flash memory, etc., in configurable logic such as, for example, programmable logic arrays (PLAs), field programmable gate arrays (FPGAs), complex programmable logic devices (CPLDs), in fixed-functionality logic hardware using circuit technology such as, for example, application specific integrated circuit (ASIC), complementary metal oxide semiconductor (CMOS) or transistor-transistor logic (TTL) technology, or any combination thereof.

For example, computer program code to carry out operations shown in the process 300 of FIG. 3 or the process 500 of FIG. 5 may be written in any combination of one or more programming languages, including an object oriented programming language such as JAVA, SMALLTALK, C++ or the like and conventional procedural programming languages, such as the “C” programming language or similar programming languages. Additionally, logic instructions might include assembler instructions, instruction set architecture (ISA) instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, etc.).

FIG. 6 shows a functional diagram of an exemplary communication device 600, in accordance with one or more example embodiments of the disclosure. In one embodiment, FIG. 6 illustrates a functional block diagram of a communication device that may be suitable for use as the AP(s) or the STA(s) in accordance with some embodiments. The communication device 600 may also be suitable for use as a handheld device, a mobile device, a cellular telephone, a smartphone, a tablet, a netbook, a wireless terminal, a laptop computer, a wearable computer device, a femtocell, a high data rate (HDR) subscriber station, an access point, an access terminal, or other personal communication system (PCS) device.

The communication device 600 may include communications circuitry 602 and a transceiver 610 for transmitting and receiving signals to and from other communication stations using one or more antennas 601. The communications circuitry 602 may include circuitry that can operate the physical layer (PHY) communications and/or medium access control (MAC) communications for controlling access to the wireless medium, and/or any other communications layers for transmitting and receiving signals. The communication device 600 may also include processing circuitry 606 and memory 608 arranged to perform the operations described herein. In some embodiments, the communications circuitry 602 and the processing circuitry 606 may be configured to perform operations detailed in the above figures, diagrams, and flows.

In accordance with some embodiments, the communications circuitry 602 may be arranged to contend for a wireless medium and configure frames or packets for communicating over the wireless medium. The communications circuitry 602 may be arranged to transmit and receive signals. The communications circuitry 602 may also include circuitry for modulation/demodulation, upconversion/downconversion, filtering, amplification, etc. In some embodiments, the processing circuitry 606 of the communication device 600 may include one or more processors. In other embodiments, two or more antennas 601 may be coupled to the communications circuitry 602 arranged for transmitting and receiving signals. The memory 608 may store information for configuring the processing circuitry 606 to perform operations for configuring and transmitting message frames and performing the various operations described herein. The memory 608 may include any type of memory, including non-transitory memory, for storing information in a form readable by a machine (e.g., a computer). For example, the memory 608 may include a computer-readable storage device, read-only memory (ROM), random-access memory (RAM), magnetic disk storage media, optical storage media, flash-memory devices and other storage devices and media.

In some embodiments, the communication device 600 may be part of a portable wireless communication device, such as a personal digital assistant (PDA), a laptop or portable computer with wireless communication capability, a web tablet, a wireless telephone, a smartphone, a wireless headset, a pager, an instant messaging device, a digital camera, an access point, a television, a medical device (e.g., a heart rate monitor, a blood pressure monitor, etc.), a wearable computer device, or another device that may receive and/or transmit information wirelessly.

In some embodiments, the communication device 600 may include one or more antennas 601. The antennas 601 may include one or more directional or omnidirectional antennas, including, for example, dipole antennas, monopole antennas, patch antennas, loop antennas, microstrip antennas, or other types of antennas suitable for transmission of RF signals. In some embodiments, instead of two or more antennas, a single antenna with multiple apertures may be used. In these embodiments, each aperture may be considered a separate antenna. In some multiple-input multiple-output (MIMO) embodiments, the antennas may be effectively separated for spatial diversity and the different channel characteristics that may result between each of the antennas and the antennas of a transmitting station.

In some embodiments, the communication device 600 may include one or more of a keyboard, a display, a non-volatile memory port, multiple antennas, a graphics processor, an application processor, speakers, and other mobile device elements. The display may be a liquid crystal display (LCD) screen including a touch screen.

Although the communication device 600 is illustrated as having several separate functional elements, two or more of the functional elements may be combined and may be implemented by combinations of software-configured elements, such as processing elements including digital signal processors (DSPs), and/or other hardware elements. For example, some elements may include one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements of the communication device 600 may refer to one or more processes operating on one or more processing elements.

Certain embodiments may be implemented in one or a combination of hardware, firmware, and software. Other embodiments may also be implemented as instructions stored on a computer-readable storage device, which may be read and executed by at least one processor to perform the operations described herein. A computer-readable storage device may include any non-transitory memory mechanism for storing information in a form readable by a machine (e.g., a computer). For example, a computer-readable storage device may include read-only memory (ROM), random-access memory (RAM), magnetic disk storage media, optical storage media, flash-memory devices, and other storage devices and media. In some embodiments, the communication device 600 may include one or more processors and may be configured with instructions stored on a computer-readable storage device.

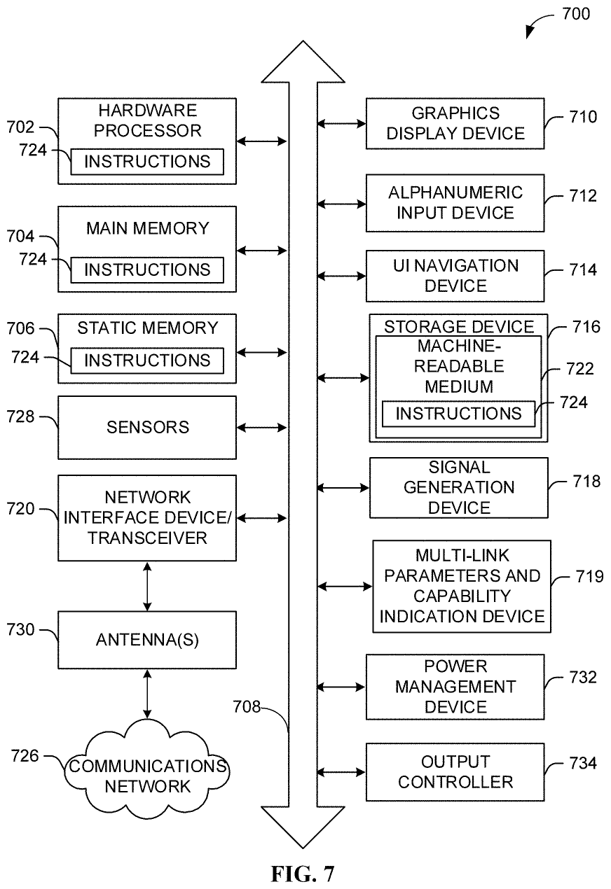

FIG. 7 illustrates a block diagram of an example of a machine 700 upon which any one or more of the techniques (e.g., methodologies) discussed herein may be performed. In other embodiments, the machine 700 may operate as a standalone device or may be connected (e.g., networked) to other machines. In a networked deployment, the machine 700 may operate in the capacity of a server machine, a client machine, or both in server-client network environments. In an example, the machine 700 may act as a peer machine in peer-to-peer (P2P) (or other distributed) network environments. The machine 700 may be a personal computer (PC), a tablet PC, a set-top box (STB), a personal digital assistant (PDA), a mobile telephone, a wearable computer device, a web appliance, a network router, a switch or bridge, or any machine capable of executing instructions (sequential or otherwise) that specify actions to be taken by that machine, such as a base station. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), or other computer cluster configurations.

Examples, as described herein, may include or may operate on logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In another example, the hardware may include configurable execution units (e.g., transistors, circuits, etc.) and a computer readable medium containing instructions where the instructions configure the execution units to carry out a specific operation when in operation. The configuring may occur under the direction of the executions units or a loading mechanism. Accordingly, the execution units are communicatively coupled to the computer-readable medium when the device is operating. In this example, the execution units may be a member of more than one module. For example, under operation, the execution units may be configured by a first set of instructions to implement a first module at one point in time and reconfigured by a second set of instructions to implement a second module at a second point in time.

The machine (e.g., computer system) 700 may include a hardware processor 702 (e.g., a central processing unit (CPU), a graphics processing unit (GPU), a hardware processor core, or any combination thereof), a main memory 704 and a static memory 706, some or all of which may communicate with each other via an interlink (e.g., bus) 708. The machine 700 may further include a power management device 732, a graphics display device 710, an alphanumeric input device 712 (e.g., a keyboard), and a user interface (UI) navigation device 714 (e.g., a mouse). In an example, the graphics display device 710, alphanumeric input device 712, and UI navigation device 714 may be a touch screen display. The machine 700 may additionally include a storage device (i.e., drive unit) 716, a signal generation device 718 (e.g., a speaker), a network interface device/transceiver 720 coupled to antenna(s) 730, and one or more sensors 728, such as a global positioning system (GPS) sensor, a compass, an accelerometer, or other sensor. The machine 700 may include an output controller 734, such as a serial (e.g., universal serial bus (USB), parallel, or other wired or wireless (e.g., infrared (IR), near field communication (NFC), etc.) connection to communicate with or control one or more peripheral devices (e.g., a printer, a card reader, etc.)). The operations in accordance with one or more example embodiments of the disclosure may be carried out by a baseband processor. The baseband processor may be configured to generate corresponding baseband signals. The baseband processor may further include physical layer (PHY) and medium access control layer (MAC) circuitry, and may further interface with the hardware processor 702 for generation and processing of the baseband signals and for controlling operations of the main memory 704, and/or the storage device 716. The baseband processor may be provided on a single radio card, a single chip, or an integrated circuit (IC).

The storage device 716 may include a machine readable medium 722 on which is stored one or more sets of data structures or instructions 724 (e.g., software) embodying or utilized by any one or more of the techniques or functions described herein. The instructions 724 may also reside, completely or at least partially, within the main memory 704, within the static memory 706, or within the hardware processor 702 during execution thereof by the machine 700. In an example, one or any combination of the hardware processor 702, the main memory 704, the static memory 706, or the storage device 716 may constitute machine-readable media.

While the machine-readable medium 722 is illustrated as a single medium, the term “machine-readable medium” may include a single medium or multiple media (e.g., a centralized or distributed database, and/or associated caches and servers) configured to store the one or more instructions 724.

Various embodiments may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; a flash memory, etc.

The term “machine-readable medium” may include any medium that is capable of storing, encoding, or carrying instructions for execution by the machine 700 and that cause the machine 700 to perform any one or more of the techniques of the disclosure, or that is capable of storing, encoding, or carrying data structures used by or associated with such instructions. Non-limiting machine-readable medium examples may include solid-state memories and optical and magnetic media. In an example, a massed machine-readable medium includes a machine-readable medium with a plurality of particles having resting mass. Specific examples of massed machine-readable media may include non-volatile memory, such as semiconductor memory devices (e.g., electrically programmable read-only memory (EPROM), or electrically erasable programmable read-only memory (EEPROM)) and flash memory devices; magnetic disks, such as internal hard disks and removable disks; magneto-optical disks; and CD-ROM and DVD-ROM disks.

The instructions 724 may further be transmitted or received over a communications network 726 using a transmission medium via the network interface device/transceiver 720 utilizing any one of a number of transfer protocols (e.g., frame relay, internet protocol (IP), transmission control protocol (TCP), user datagram protocol (UDP), hypertext transfer protocol (HTTP), etc.). Example communications networks may include a local area network (LAN), a wide area network (WAN), a packet data network (e.g., the Internet), mobile telephone networks (e.g., cellular networks), plain old telephone (POTS) networks, wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, and peer-to-peer (P2P) networks, among others. In an example, the network interface device/transceiver 720 may include one or more physical jacks (e.g., Ethernet, coaxial, or phone jacks) or one or more antennas to connect to the communications network 726. In an example, the network interface device/transceiver 720 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding, or carrying instructions for execution by the machine 700 and includes digital or analog communications signals or other intangible media to facilitate communication of such software. The instructions may implement one or more aspects of the methods/processes described above, including the operations of FIG. 3, and the operations of FIG. 5 as described herein.

The operations and processes described and shown above may be carried out or performed in any suitable order as desired in various implementations. Additionally, in certain implementations, at least a portion of the operations may be carried out in parallel. Furthermore, in certain implementations, less than or more than the operations described may be performed.

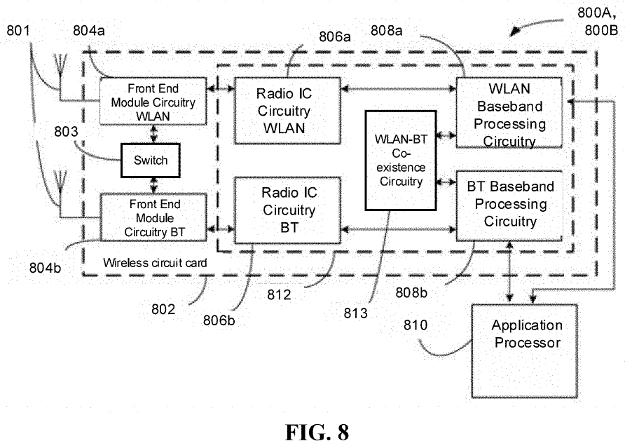

FIG. 8 is a block diagram of a radio architecture 800 in accordance with some embodiments. The radio architecture 800 may be implemented in any of the AP(s) and/or STA(s). Radio architecture 800 may include radio front-end module (FEM) circuitry 804a-b, radio IC circuitry 806a-b and baseband processing circuitry 808a-b. Radio architecture 800 as shown includes both Wireless Local Area Network (WLAN) functionality and Bluetooth (BT) functionality although embodiments are not so limited. In this disclosure, “WLAN” and “Wi-Fi” are used interchangeably.

FEM circuitry 804a-b may include a WLAN or Wi-Fi FEM circuitry 804a and a Bluetooth (BT) FEM circuitry 804b. The WLAN FEM circuitry 804a may include a receive signal path comprising circuitry configured to operate on WLAN RF signals received from one or more antennas 801, to amplify the received signals and to provide the amplified versions of the received signals to the WLAN radio IC circuitry 806a for further processing. The BT FEM circuitry 804b may include a receive signal path which may include circuitry configured to operate on BT RF signals received from one or more antennas 801, to amplify the received signals and to provide the amplified versions of the received signals to the BT radio IC circuitry 806b for further processing. FEM circuitry 804a may also include a transmit signal path which may include circuitry configured to amplify WLAN signals provided by the radio IC circuitry 806a for wireless transmission by one or more of the antennas 801. In addition, FEM circuitry 804b may also include a transmit signal path which may include circuitry configured to amplify BT signals provided by the radio IC circuitry 806b for wireless transmission by the one or more antennas. In the embodiment of FIG. 8, although FEM 804a and FEM 804b are shown as being distinct from one another, embodiments are not so limited, and include within their scope the use of an FEM (not shown) that includes a transmit path and/or a receive path for both WLAN and BT signals, or the use of one or more FEM circuitries where at least some of the FEM circuitries share transmit and/or receive signal paths for both WLAN and BT signals.

Radio IC circuitry 806a-b as shown may include WLAN radio IC circuitry 806a and BT radio IC circuitry 806b. The WLAN radio IC circuitry 806a may include a receive signal path which may include circuitry to down-convert WLAN RF signals received from the FEM circuitry 804a and provide baseband signals to WLAN baseband processing circuitry 808a. BT radio IC circuitry 806b may in turn include a receive signal path which may include circuitry to down-convert BT RF signals received from the FEM circuitry 804b and provide baseband signals to BT baseband processing circuitry 808b. WLAN radio IC circuitry 806a may also include a transmit signal path which may include circuitry to up-convert WLAN baseband signals provided by the WLAN baseband processing circuitry 808a and provide WLAN RF output signals to the FEM circuitry 804a for subsequent wireless transmission by the one or more antennas 801. BT radio IC circuitry 806b may also include a transmit signal path which may include circuitry to up-convert BT baseband signals provided by the BT baseband processing circuitry 808b and provide BT RF output signals to the FEM circuitry 804b for subsequent wireless transmission by the one or more antennas 801. In the embodiment of FIG. 8, although radio IC circuitries 806a and 806b are shown as being distinct from one another, embodiments are not so limited, and include within their scope the use of a radio IC circuitry (not shown) that includes a transmit signal path and/or a receive signal path for both WLAN and BT signals, or the use of one or more radio IC circuitries where at least some of the radio IC circuitries share transmit and/or receive signal paths for both WLAN and BT signals.

Baseband processing circuitry 808a-b may include a WLAN baseband processing circuitry 808a and a BT baseband processing circuitry 808b. The WLAN baseband processing circuitry 808a may include a memory, such as, for example, a set of RAM arrays in a Fast Fourier Transform or Inverse Fast Fourier Transform block (not shown) of the WLAN baseband processing circuitry 808a. Each of the WLAN baseband circuitry 808a and the BT baseband circuitry 808b may further include one or more processors and control logic to process the signals received from the corresponding WLAN or BT receive signal path of the radio IC circuitry 806a-b, and to also generate corresponding WLAN or BT baseband signals for the transmit signal path of the radio IC circuitry 806a-b. Each of the baseband processing circuitries 808a and 808b may further include physical layer (PHY) and medium access control layer (MAC) circuitry, and may further interface with a device for generation and processing of the baseband signals and for controlling operations of the radio IC circuitry 806a-b.

Referring still to FIG. 8, according to the shown embodiment, WLAN-BT coexistence circuitry 813 may include logic providing an interface between the WLAN baseband circuitry 808a and the BT baseband circuitry 808b to enable use cases requiring WLAN and BT coexistence. In addition, a switch 803 may be provided between the WLAN FEM circuitry 804a and the BT FEM circuitry 804b to allow switching between the WLAN and BT radios according to application needs. In addition, although the antennas 801 are depicted as being respectively connected to the WLAN FEM circuitry 804a and the BT FEM circuitry 804b, embodiments include within their scope the sharing of one or more antennas as between the WLAN and BT FEMs, or the provision of more than one antenna connected to each of FEM 804a or 804b.

In some embodiments, the front-end module circuitry 804a-b, the radio IC circuitry 806a-b, and baseband processing circuitry 808a-b may be provided on a single radio card, such as wireless radio card 9. In some other embodiments, the one or more antennas 801, the FEM circuitry 804a-b and the radio IC circuitry 806a-b may be provided on a single radio card. In some other embodiments, the radio IC circuitry 806a-b and the baseband processing circuitry 808a-b may be provided on a single chip or integrated circuit (IC), such as IC 812.

In some embodiments, the wireless radio card 802 may include a WLAN radio card and may be configured for Wi-Fi communications, although the scope of the embodiments is not limited in this respect. In some of these embodiments, the radio architecture 800 may be configured to receive and transmit orthogonal frequency division multiplexed (OFDM) or orthogonal frequency division multiple access (OFDMA) communication signals over a multicarrier communication channel. The OFDM or OFDMA signals may comprise a plurality of orthogonal subcarriers.

In some of these multicarrier embodiments, radio architecture 800 may be part of a Wi-Fi communication station (STA) such as a wireless access point (AP), a base station or a mobile device including a Wi-Fi device. In some of these embodiments, radio architecture 800 may be configured to transmit and receive signals in accordance with specific communication standards and/or protocols, such as any of the Institute of Electrical and Electronics Engineers (IEEE) standards including, 802.11n-2009, IEEE 802.11-2012, IEEE 802.11-2016, 802.11n-2009, 802.11ac, 802.11ah, 802.11ad, 802.11 ay, 802.11ax and/or 802.11be standards and/or proposed specifications for WLANs, although the scope of embodiments is not limited in this respect. Radio architecture 900 may also be suitable to transmit and/or receive communications in accordance with other techniques and standards.

In some embodiments, the radio architecture 800 may be configured for high-efficiency Wi-Fi (HEW) communications in accordance with the IEEE 802.11ax standard. In these embodiments, the radio architecture 800 may be configured to communicate in accordance with an OFDMA technique, although the scope of the embodiments is not limited in this respect.

In some other embodiments, the radio architecture 800 may be configured to transmit and receive signals transmitted using one or more other modulation techniques such as spread spectrum modulation (e.g., direct sequence code division multiple access (DS-CDMA) and/or frequency hopping code division multiple access (FH-CDMA)), time-division multiplexing (TDM) modulation, and/or frequency-division multiplexing (FDM) modulation, although the scope of the embodiments is not limited in this respect.

In some embodiments, as further shown in FIG. 8, the BT baseband circuitry 908b may be compliant with a Bluetooth (BT) connectivity standard such as Bluetooth, Bluetooth 8.0 or Bluetooth 6.0, or any other iteration of the Bluetooth Standard.

In some embodiments, the radio architecture 800 may include other radio cards, such as a cellular radio card configured for cellular (e.g., 3GPP such as LTE, LTE-Advanced or 5G communications).

In some IEEE 802.11 embodiments, the radio architecture 800 may be configured for communication over various channel bandwidths including bandwidths having center frequencies of about 900 MHz, 2.4 GHz, 5 GHz, and bandwidths of about 2 MHz, 4 MHz, 5 MHz, 5.5 MHz, 6 MHz, 8 MHz, 10 MHz, 20 MHz, 40 MHz, 80 MHz (with contiguous bandwidths) or 80+80 MHz (160 MHz) (with non-contiguous bandwidths). In some embodiments, a 320 MHz channel bandwidth may be used. The scope of the embodiments is not limited with respect to the above center frequencies however.

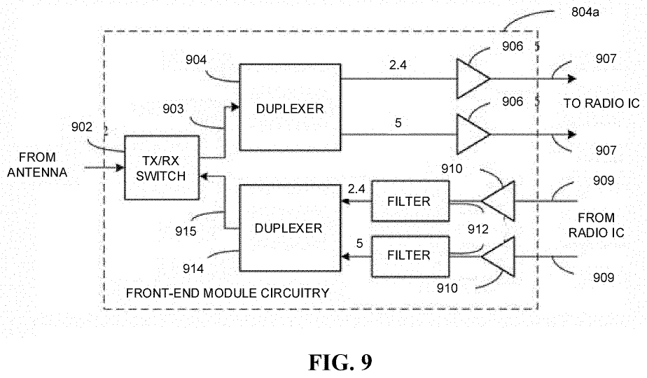

FIG. 9 illustrates WLAN FEM circuitry 804a in accordance with some embodiments. Although the example of FIG. 9 is described in conjunction with the WLAN FEM circuitry 804a, the example of FIG. 9 may be described in conjunction with the example BT FEM circuitry 804b (FIG. 8), although other circuitry configurations may also be suitable.

In some embodiments, the FEM circuitry 804a may include a TX/RX switch 902 to switch between transmit mode and receive mode operation. The FEM circuitry 804a may include a receive signal path and a transmit signal path. The receive signal path of the FEM circuitry 804a may include a low-noise amplifier (LNA) 906 to amplify received RF signals 903 and provide the amplified received RF signals 907 as an output (e.g., to the radio IC circuitry 806a-b (FIG. 8)). The transmit signal path of the circuitry 804a may include a power amplifier (PA) to amplify input RF signals 909 (e.g., provided by the radio IC circuitry 806a-b), and one or more filters 912, such as band-pass filters (BPFs), low-pass filters (LPFs) or other types of filters, to generate RF signals 915 for subsequent transmission (e.g., by one or more of the antennas 801 (FIG. 8)) via an example duplexer 914.

In some dual-mode embodiments for Wi-Fi communication, the FEM circuitry 804a may be configured to operate in either the 2.4 GHz frequency spectrum or the 5 GHz frequency spectrum. In these embodiments, the receive signal path of the FEM circuitry 804a may include a receive signal path duplexer 904 to separate the signals from each spectrum as well as provide a separate LNA 906 for each spectrum as shown. In these embodiments, the transmit signal path of the FEM circuitry 804a may also include a power amplifier 910 and a filter 912, such as a BPF, an LPF or another type of filter for each frequency spectrum and a transmit signal path duplexer 904 to provide the signals of one of the different spectrums onto a single transmit path for subsequent transmission by the one or more of the antennas 801 (FIG. 8). In some embodiments, BT communications may utilize the 2.4 GHz signal paths and may utilize the same FEM circuitry 804a as the one used for WLAN communications.

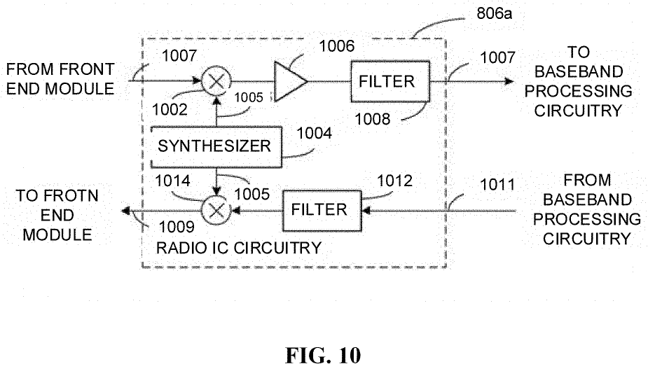

FIG. 10 illustrates radio IC circuitry 806a in accordance with some embodiments. The radio IC circuitry 806a is one example of circuitry that may be suitable for use as the WLAN or BT radio IC circuitry 806a/806b (FIG. 8), although other circuitry configurations may also be suitable. Alternatively, the example of FIG. 10 may be described in conjunction with the example BT radio IC circuitry 806b.

In some embodiments, the radio IC circuitry 806a may include a receive signal path and a transmit signal path. The receive signal path of the radio IC circuitry 806a may include at least mixer circuitry 1002, such as, for example, down-conversion mixer circuitry, amplifier circuitry 1006 and filter circuitry 1008. The transmit signal path of the radio IC circuitry 806a may include at least filter circuitry 1012 and mixer circuitry 1014, such as, for example, up-conversion mixer circuitry. Radio IC circuitry 806a may also include synthesizer circuitry 1004 for synthesizing a frequency 1005 for use by the mixer circuitry 1002 and the mixer circuitry 1014. The mixer circuitry 1002 and/or 1014 may each, according to some embodiments, be configured to provide direct conversion functionality. The latter type of circuitry presents a much simpler architecture as compared with standard super-heterodyne mixer circuitries, and any flicker noise brought about by the same may be alleviated for example through the use of OFDM modulation. FIG. 10 illustrates only a simplified version of a radio IC circuitry, and may include, although not shown, embodiments where each of the depicted circuitries may include more than one component. For instance, mixer circuitry 1014 may each include one or more mixers, and filter circuitries 1008 and/or 1012 may each include one or more filters, such as one or more BPFs and/or LPFs according to application needs. For example, when mixer circuitries are of the direct-conversion type, they may each include two or more mixers.

In some embodiments, mixer circuitry 1002 may be configured to down-convert RF signals 907 received from the FEM circuitry 804a-b (FIG. 8) based on the synthesized frequency 1005 provided by synthesizer circuitry 1004. The amplifier circuitry 1006 may be configured to amplify the down-converted signals and the filter circuitry 1008 may include an LPF configured to remove unwanted signals from the down-converted signals to generate output baseband signals 1007. Output baseband signals 1007 may be provided to the baseband processing circuitry 808a-b (FIG. 8) for further processing. In some embodiments, the output baseband signals 1007 may be zero-frequency baseband signals, although this is not a requirement. In some embodiments, mixer circuitry 1002 may comprise passive mixers, although the scope of the embodiments is not limited in this respect.

In some embodiments, the mixer circuitry 1014 may be configured to up-convert input baseband signals 1011 based on the synthesized frequency 1005 provided by the synthesizer circuitry 1004 to generate RF output signals 909 for the FEM circuitry 804a-b. The baseband signals 1011 may be provided by the baseband processing circuitry 808a-b and may be filtered by filter circuitry 1012. The filter circuitry 1012 may include an LPF or a BPF, although the scope of the embodiments is not limited in this respect.

In some embodiments, the mixer circuitry 1002 and the mixer circuitry 1014 may each include two or more mixers and may be arranged for quadrature down-conversion and/or up-conversion respectively with the help of synthesizer 1004. In some embodiments, the mixer circuitry 1002 and the mixer circuitry 1014 may each include two or more mixers each configured for image rejection (e.g., Hartley image rejection). In some embodiments, the mixer circuitry 1002 and the mixer circuitry 1014 may be arranged for direct down-conversion and/or direct up-conversion, respectively. In some embodiments, the mixer circuitry 1002 and the mixer circuitry 1014 may be configured for super-heterodyne operation, although this is not a requirement.

Mixer circuitry 1002 may comprise, according to one embodiment: quadrature passive mixers (e.g., for the in-phase (I) and quadrature phase (Q) paths). In such an embodiment, RF input signal 907 from FIG. 10 may be down-converted to provide I and Q baseband output signals to be transmitted to the baseband processor.

Quadrature passive mixers may be driven by zero and ninety-degree time-varying LO switching signals provided by a quadrature circuitry which may be configured to receive a LO frequency (fLO) from a local oscillator or a synthesizer, such as LO frequency 1005 of synthesizer 1004 (FIG. 10). In some embodiments, the LO frequency may be the carrier frequency, while in other embodiments, the LO frequency may be a fraction of the carrier frequency (e.g., one-half the carrier frequency, one-third the carrier frequency). In some embodiments, the zero and ninety-degree time-varying switching signals may be generated by the synthesizer, although the scope of the embodiments is not limited in this respect.

In some embodiments, the LO signals may differ in duty cycle (the percentage of one period in which the LO signal is high) and/or offset (the difference between start points of the period). In some embodiments, the LO signals may have an 85% duty cycle and an 80% offset. In some embodiments, each branch of the mixer circuitry (e.g., the in-phase (I) and quadrature phase (Q) path) may operate at an 80% duty cycle, which may result in a significant reduction is power consumption.

The RF input signal 907 (FIG. 9) may comprise a balanced signal, although the scope of the embodiments is not limited in this respect. The I and Q baseband output signals may be provided to low-noise amplifier, such as amplifier circuitry 1006 (FIG. 10) or to filter circuitry 1008 (FIG. 10).

In some embodiments, the output baseband signals 1007 and the input baseband signals 1011 may be analog baseband signals, although the scope of the embodiments is not limited in this respect. In some alternate embodiments, the output baseband signals 1007 and the input baseband signals 1011 may be digital baseband signals. In these alternate embodiments, the radio IC circuitry may include analog-to-digital converter (ADC) and digital-to-analog converter (DAC) circuitry.

In some dual-mode embodiments, a separate radio IC circuitry may be provided for processing signals for each spectrum, or for other spectrums not mentioned here, although the scope of the embodiments is not limited in this respect.

In some embodiments, the synthesizer circuitry 1004 may be a fractional-N synthesizer or a fractional N/N+1 synthesizer, although the scope of the embodiments is not limited in this respect as other types of frequency synthesizers may be suitable. For example, synthesizer circuitry 1004 may be a delta-sigma synthesizer, a frequency multiplier, or a synthesizer comprising a phase-locked loop with a frequency divider. According to some embodiments, the synthesizer circuitry 1004 may include digital synthesizer circuitry. An advantage of using a digital synthesizer circuitry is that, although it may still include some analog components, its footprint may be scaled down much more than the footprint of an analog synthesizer circuitry. In some embodiments, frequency input into synthesizer circuitry 1004 may be provided by a voltage controlled oscillator (VCO), although that is not a requirement. A divider control input may further be provided by either the baseband processing circuitry 808a-b (FIG. 8) depending on the desired output frequency 1005. In some embodiments, a divider control input (e.g., N) may be determined from a look-up table (e.g., within a Wi-Fi card) based on a channel number and a channel center frequency as determined or indicated by the example application processor 810. The application processor 810 may include, or otherwise be connected to, one of the example security signal converter 101 or the example received signal converter 103 (e.g., depending on which device the example radio architecture is implemented in).

In some embodiments, synthesizer circuitry 1004 may be configured to generate a carrier frequency as the output frequency 1005, while in other embodiments, the output frequency 1005 may be a fraction of the carrier frequency (e.g., one-half the carrier frequency, one-third the carrier frequency). In some embodiments, the output frequency 1005 may be a LO frequency (fLO).

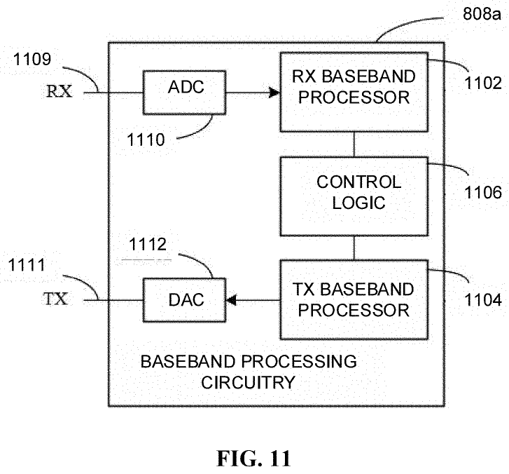

FIG. 11 illustrates a functional block diagram of baseband processing circuitry 808a in accordance with some embodiments. The baseband processing circuitry 808a is one example of circuitry that may be suitable for use as the baseband processing circuitry 808a (FIG. 8), although other circuitry configurations may also be suitable. Alternatively, the example of FIG. 10 may be used to implement the example BT baseband processing circuitry 808b of FIG. 8.

The baseband processing circuitry 808a may include a receive baseband processor (RX BBP) 1102 for processing receive baseband signals 1009 provided by the radio IC circuitry 806a-b (FIG. 8) and a transmit baseband processor (TX BBP) 1104 for generating transmit baseband signals 1011 for the radio IC circuitry 806a-b. The baseband processing circuitry 808a may also include control logic 1106 for coordinating the operations of the baseband processing circuitry 808a.

In some embodiments (e.g., when analog baseband signals are exchanged between the baseband processing circuitry 808a-b and the radio IC circuitry 806a-b), the baseband processing circuitry 808a may include ADC 1110 to convert analog baseband signals 1109 received from the radio IC circuitry 806a-b to digital baseband signals for processing by the RX BBP 1102. In these embodiments, the baseband processing circuitry 808a may also include DAC 1112 to convert digital baseband signals from the TX BBP 1104 to analog baseband signals 1111.

In some embodiments that communicate OFDM signals or OFDMA signals, such as through baseband processor 808a, the transmit baseband processor 1104 may be configured to generate OFDM or OFDMA signals as appropriate for transmission by performing an inverse fast Fourier transform (IFFT). The receive baseband processor 1102 may be configured to process received OFDM signals or OFDMA signals by performing an FFT. In some embodiments, the receive baseband processor 1102 may be configured to detect the presence of an OFDM signal or OFDMA signal by performing an autocorrelation, to detect a preamble, such as a short preamble, and by performing a cross-correlation, to detect a long preamble. The preambles may be part of a predetermined frame structure for Wi-Fi communication.

Referring back to FIG. 8, in some embodiments, the antennas 801 (FIG. 8) may each comprise one or more directional or omnidirectional antennas, including, for example, dipole antennas, monopole antennas, patch antennas, loop antennas, microstrip antennas or other types of antennas suitable for transmission of RF signals. In some multiple-input multiple-output (MIMO) embodiments, the antennas may be effectively separated to take advantage of spatial diversity and the different channel characteristics that may result. Antennas 801 may each include a set of phased-array antennas, although embodiments are not so limited.

Although the radio architecture 800 is illustrated as having several separate functional elements, one or more of the functional elements may be combined and may be implemented by combinations of software-configured elements, such as processing elements including digital signal processors (DSPs), and/or other hardware elements. For example, some elements may comprise one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements may refer to one or more processes operating on one or more processing elements.

The following paragraphs describe examples of various embodiments.

Example 1 includes an apparatus for a STA, comprising a PHY circuitry and a MAC circuitry, wherein the PHY circuitry is configured to: obtain WLAN sensing measurements for a received physical layer protocol data unit (PPDU); provide the WLAN sensing measurements to the MAC circuitry via a RXVECTOR parameter, wherein the RXVECTOR parameter allows for the PHY layer of the STA to inform the MAC layer of the STA of the WLAN sensing measurements.

Example 2 includes the apparatus of Example 1, wherein the WLAN sensing measurements comprise CSI measurements.

Example 3 includes the apparatus of Examples 1 or 2, wherein the RXVECTOR parameter is incorporated into a PHY service interface of each sub-7 GHZ PHY comprising HT PHY, VHT PHY, HE PHY, and EHT PHY.

Example 4 includes the apparatus of any of Examples 1-3, wherein the RXVECTOR parameter comprise a parameter of CSI_ESTIMATE, and wherein the parameter of CSI_ESTIMATE contains a vector in the number of selected subcarriers that contains the channel measured during the training symbols of the received PPDU.

Example 5 includes the apparatus of any of Examples 1-4, wherein the received PPDU is one of HT PPDU, VHT PPDU, HE PPDU, and EHT PPDU.

Example 6 includes the apparatus of any of Examples 1-5, wherein the parameter of CSI_ESTIMATE is present in the RXVECTOR when dot11CSIMsmtActivated is activated.

Example 7 includes the apparatus of any of Examples 1-6, wherein the WLAN sensing measurements comprise SNR measurements.

Example 8 includes the apparatus of any of Examples 1-7, wherein the MAC circuitry is configured to: obtain WLAN sensing measurements based on the RXVECTOR parameter.

Example 9 includes the apparatus of any of Examples 1-8, wherein the MAC circuitry is configured to: provide the WLAN sensing measurements to layers above the MAC layer.

Example 10 includes the apparatus of any of Examples 1-9, wherein the PHY service interface comprises a PHY Service Access Point (SAP) interface.

Example 11 includes an apparatus for a Station (STA), comprising: interface circuitry; and processor circuitry coupled with the interface circuitry and configured to: encode a frame for sensing measurement reporting; provide the frame to the interface circuitry for transmission to a receiving STA, wherein the frame comprises a Sensing Measurement Report frame and/or a Protected Sensing frame.

Example 12 includes the apparatus of Example 11, wherein every of the Sensing Measurement Report frame and the Protected Sensing frame comprises a CSI Measurement Report Control field and a CSI Measurement Report field.

Example 13 includes the apparatus of Examples 11 or 12, wherein the CSI Measurement Report Control field comprises information necessary for the receiving STA to interpret the CSI Measurement Report field.

Example 14 includes the apparatus of any of Examples 11-13, wherein the CSI Measurement Report Control field comprises the following subfields: PPDU Format, HE/EHT PPDU, Nᵣ Index, Nc index, BW, HE BW, RU Start Index, RU End Index, Grouping (N_{g}), and Coefficient size (N_{b}).

Example 15 includes the apparatus of any of Examples 11-14, wherein the CSI Measurement Report field is to carry WLAN sensing measurements obtained by a sensing receiver.

Example 16 includes the apparatus of any of Examples 11-15, wherein the WLAN sensing measurements comprise CSI measurements.

Example 17 includes the apparatus of any of Examples 11-16, wherein the WLAN sensing measurements comprise SNR measurements.

Example 18 includes the apparatus of any of Examples 11-17, wherein The CSI Measurement Report field comprises channel matrix elements indexed by data and pilot subcarrier index from lowest frequency to highest frequency.

Example 19 includes the apparatus of any of Examples 11-18, wherein the Sensing Measurement Report frame is an Action No Ack frame of category Public.

Example 20 includes the apparatus of any of Examples 11-19, wherein the Protected Sensing frame comprises an Action field and a Category field, wherein the Action field is in the octet immediately after the Category field to differentiate between various Protected Sensing frames.

Example 21 includes a method for a STA, comprising: obtaining, by a PHY circuitry of the STA, WLAN sensing measurements for a received physical layer protocol data unit (PPDU); providing, by the PHY circuitry of the STA, the WLAN sensing measurements to a MAC circuitry of the STA via a RXVECTOR parameter, wherein the RXVECTOR parameter allows for a PHY layer of the STA to inform a MAC layer of the STA of the WLAN sensing measurements.

Example 22 includes the method of Example 21, wherein the WLAN sensing measurements comprise CSI measurements.

Example 23 includes the method of Example 21 or 22, wherein the RXVECTOR parameter is incorporated into a PHY service interface of each sub-7 GHZ PHY comprising HT PHY, VHT PHY, HE PHY, and EHT PHY.

Example 24 includes the method of any of Examples 21-23, wherein the RXVECTOR parameter comprise a parameter of CSI_ESTIMATE, and wherein the parameter of CSI_ESTIMATE contains a vector in the number of selected subcarriers that contains the channel measured during the training symbols of the received PPDU.

Example 25 includes the method of any of Examples 21-24, wherein the received PPDU is one of HT PPDU, VHT PPDU, HE PPDU, and EHT PPDU.

Example 26 includes the method of any of Examples 21-25, wherein the parameter of CSI_ESTIMATE is present in the RXVECTOR when dot11CSIMsmtActivated is activated.

Example 27 includes the method of any of Examples 21-26, wherein the WLAN sensing measurements comprise SNR measurements.

Example 28 includes the method of any of Examples 21-27, further comprising: obtaining, by the MAC circuitry of the STA, WLAN sensing measurements based on the RXVECTOR parameter.

Example 29 includes the method of any of Examples 21-28, further comprising: providing, by the MAC circuitry of the STA, the WLAN sensing measurements to layers above the MAC layer.

Example 30 includes the method of any of Examples 21-29, wherein the PHY service interface comprises a PHY Service Access Point (SAP) interface.

Example 31 includes a method for a Station (STA), comprising: encoding a frame for sensing measurement reporting; providing the frame for transmission to a receiving STA, wherein the frame comprises a Sensing Measurement Report frame and/or a Protected Sensing frame.

Example 32 includes the method of Example 31, wherein every of the sensing measurement report frame and the protected sensing frame comprises a CSI Measurement Report Control field and a CSI Measurement Report field.

Example 33 includes the method of Example 31 or 32, wherein the CSI Measurement Report Control field contains information necessary for the receiving STA to interpret the CSI Measurement Report field.

Example 34 includes the method of any of Examples 31-33, wherein the CSI Measurement Report Control field comprises the following subfields: PPDU Format, HE/EHT PPDU, Nᵣ Index, Nc index, BW, HE BW, RU Start Index, RU End Index, Grouping (N_{g}), and Coefficient size (N_{b}).

Example 35 includes the method of any of Examples 31-34, wherein the CSI Measurement Report field is to carry WLAN sensing measurements obtained by a sensing receiver.

Example 36 includes the method of any of Examples 31-35, wherein the WLAN sensing measurements comprise CSI measurements.

Example 37 includes the method of any of Examples 31-36, wherein the WLAN sensing measurements comprise SNR measurements.

Example 38 includes the method of any of Examples 31-37, wherein The CSI Measurement Report field comprises channel matrix elements indexed by data and pilot subcarrier index from lowest frequency to highest frequency.

Example 39 includes the method of any of Examples 31-38, wherein the sensing measurement report frame is an Action No Ack frame of category Public.

Example 40 includes the method of any of Examples 31-39, wherein the protected sensing frame comprises an Action field in the octet immediately after a Category field to differentiate between various protected sensing frames.

Example 41 includes computer-readable medium having instructions stored thereon, wherein the instructions, when executed by processor circuitry of a Station (STA), cause the processor circuitry to perform the method of any of Examples 21-30.

Example 42 includes an apparatus comprising means for performing the actions of the method of any of Examples 21-30.

Example 43 includes a computer-readable medium having instructions stored thereon, wherein the instructions, when executed by processor circuitry of a Station (STA), cause the processor circuitry to perform the method of any of Examples 31-40.

Example 44 includes an apparatus comprising means for performing the actions of the method of any of Examples 31-40.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments may be used, such as by one of ordinary skill in the art upon reviewing the above description. The Abstract is to allow the reader to quickly ascertain the nature of the technical disclosure and is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the embodiments should be determined with reference to the appended claims, along with the full scope of equivalents to which such claims are entitled.

What is claimed is:

1. An apparatus for a Station (STA), comprising a Physical Layer (PHY) circuitry and a Media Access Control (MAC) circuitry, wherein the PHY circuitry is configured to:
obtain Wireless Local Area Network (WLAN) sensing measurements for a received physical layer protocol data unit (PPDU);
provide the WLAN sensing measurements to the MAC circuitry via a RXVECTOR parameter, wherein the RXVECTOR parameter allows for the PHY layer of the STA to inform the MAC layer of the STA of the WLAN sensing measurements.

2. The apparatus of claim 1, wherein the WLAN sensing measurements comprise Channel State Information (CSI) measurements.

3. The apparatus of claim 1, wherein the RXVECTOR parameter is incorporated into a PHY service interface of each sub-7 GHZ PHY comprising HT PHY, VHT PHY, HE PHY, and EHT PHY.

4. The apparatus of claim 2, wherein the RXVECTOR parameter comprise a parameter of CSI_ESTIMATE, and wherein the parameter of CSI_ESTIMATE contains a vector in the number of selected subcarriers that contains the channel measured during the training symbols of the received PPDU.

5. The apparatus of claim 4, wherein the received PPDU is one of HT PPDU, VHT PPDU, HE PPDU, and EHT PPDU.

6. The apparatus of claim 3, wherein the parameter of CSI_ESTIMATE is present in the RXVECTOR when dot11CSIMsmtActivated is activated.

7. The apparatus of claim 1, wherein the WLAN sensing measurements comprise Signal Noise Ratio (SNR) measurements.

8. The apparatus of claim 1, wherein the MAC circuitry is configured to:
obtain WLAN sensing measurements based on the RXVECTOR parameter.

9. The apparatus of claim 8, wherein the MAC circuitry is configured to:
provide the WLAN sensing measurements to layers above the MAC layer.

10. The apparatus of claim 3, wherein the PHY service interface comprises a PHY Service Access Point (SAP) interface.

11. An apparatus for a Station (STA), comprising:
interface circuitry; and
processor circuitry coupled with the interface circuitry and configured to:
encode a frame for sensing measurement reporting;
provide the frame to the interface circuitry for transmission to a receiving STA,
wherein the frame comprises a Sensing Measurement Report frame and/or a Protected Sensing frame.

12. The apparatus of claim 11, wherein every of the Sensing Measurement Report frame and the Protected Sensing frame comprises a Channel State Information (CSI) Measurement Report Control field and a CSI Measurement Report field.

13. The apparatus of claim 11, wherein the CSI Measurement Report Control field comprises information necessary for the receiving STA to interpret the CSI Measurement Report field.

14. The apparatus of claim 12, wherein the CSI Measurement Report Control field comprises the following subfields: PPDU Format, HE/EHT PPDU, Nᵣ Index, Nc index, BW, HE BW, RU Start Index, RU End Index, Grouping (N_{g}), and Coefficient size (N_{b}).

15. The apparatus of claim 12, wherein the CSI Measurement Report field is to carry WLAN sensing measurements obtained by a sensing receiver.

16. The apparatus of claim 15, wherein the WLAN sensing measurements comprise CSI measurements.

17. The apparatus of claim 15, wherein the WLAN sensing measurements comprise Signal Noise Ratio (SNR) measurements.

18. The apparatus of claim 15, wherein The CSI Measurement Report field comprises channel matrix elements indexed by data and pilot subcarrier index from lowest frequency to highest frequency.

19. The apparatus of claim 11, wherein the Sensing Measurement Report frame is an Action No Ack frame of category Public.

20. The apparatus of claim 11, wherein the Protected Sensing frame comprises an Action field and a Category field, wherein the Action field is in the octet immediately after the Category field to differentiate between various Protected Sensing frames.

21. A method for a Station (STA), comprising:
obtaining, by a Physical Layer (PHY) circuitry of the STA, Wireless Local Area Network (WLAN) sensing measurements for a received physical layer protocol data unit (PPDU);
providing, by the PHY circuitry of the STA, the WLAN sensing measurements to a Media Access Control (MAC) circuitry of the STA via a RXVECTOR parameter, wherein the RXVECTOR parameter allows for a PHY layer of the STA to inform a MAC layer of the STA of the WLAN sensing measurements.

22. The method of claim 21, wherein the WLAN sensing measurements comprise Channel State Information (CSI) measurements.

23. The method of claim 21, wherein the RXVECTOR parameter is incorporated into a PHY service interface of each sub-7 GHZ PHY comprising HT PHY, VHT PHY, HE PHY, and EHT PHY.

24. The method of claim 22, wherein the RXVECTOR parameter comprise a parameter of CSI_ESTIMATE, and wherein the parameter of CSI_ESTIMATE contains a vector in the number of selected subcarriers that contains the channel measured during the training symbols of the received PPDU.

25. The method of claim 23, wherein the parameter of CSI_ESTIMATE is present in the RXVECTOR when dot11CSIMsmtActivated is activated.
